(19) United States
(12) Patent Application Publication
(10) Pub. No.: US 2014/0224720 A1
(43) Pub. Date: Aug. 14, 2014

(54) WATER CLEANING SYSTEM

(71) Applicant: Guido Kohler, Schindellegi (CH)

(72) Inventor: Guido Kohler, Schindellegi (CH)

(21) Appl. No.: 14/350,754

(22) PCT Filed: Oct. 8, 2012
(86) PCT No.: PCT/EP2012/069879

§ 371 Date: Apr. 9, 2014

(30) Foreign Application Priority Data
Oct. 11, 2011 (CH) CH 1656/11

(51) Int. Cl. C02F 1/00

(52) U.S. Cl. CPC C02F 1/00
USPC 210/232; 285/335

(57) ABSTRACT

Adapter for a water cleaning having a first and second connection mechanism each for connecting a first and second mechanical part to the adapter. A first and second connection surface of the adapter is defined by the surface of the adapter enclosed within the first and second connection mechanism by the first and second mechanical part, respectively, when the first and second mechanical part is connected to the first and second connection mechanism, respectively. A first conduit is provided connecting a first opening in the first connection surface and a second opening in the second connection surface. A second conduit connects a second opening in the first connection surface and a first opening in the second connection surface.

### REFERENCE

The Paris Convention priority of the Swiss patent application CH2011/1656 is claimed. The content of the same is hereby incorporated by reference.

### FIELD OF THE INVENTION

The present invention relates to adapter, valve, water meter, pump and system for water cleaning.

### DESCRIPTION OF RELATED ART

Water cleaning systems are modular. Depending on the local needs, pre-filter, filter, disinfection modules, pumps, water meter, valves, emergency water outlets, etc. are combined in order to achieve the desired effect. Unfortunately, the space needed for installing the water cleaning system directly proportional with the number of modules. A tube of a water cleaning system comprising normally water cleaning modules like a shut-off valve, an emergency water access to take of water if the water cleaning systems fails, a water meter, filter, pumps, etc. Each module has a first connection mechanism for the water inlet and a second connection mechanism for the water outlet which are normally arranged at 180° such that the module can be build-in a tube. Between each module, a pressure gauge module is needed which measures the pressure between two module. Also the pressure gauge module has a first connection mechanism for the water inlet and a second connection mechanism for the water outlet which are normally arranged at 180° such that the module can be build-in a tube. Therefore, in order two install a number of modules of the water cleaning system, the accumulated length of the number of water cleaning modules and of the same number of three pressure gauge modules are needed to install such a water cleaning system. However, it is in general desired that a high number of water cleaning modules can also be installed in rooms which do not provide the necessary length for all water cleaning modules. In the following, disclosures for valves are presented which all show such two connection mechanism for each valve.

U.S. Pat. No. 4,248,402 discloses a valve body which defines an inlet and an outlet with a valve seat therebetween. A flexible diaphragm valve member has an outer portion supported by the valve body and a movable inner portion which cooperates with the valve seat to control the flow of liquid from the inlet to the outlet. A small bleed hole extends through the diaphragm valve member and provides a limited flow of liquid which is adapted to be vented to the outlet through a slightly larger vent passage defined by the valve body. The vent passage is opened and closed by over-center snap movement of a concaved bimetal disc positioned within the vent passage. The disc is heated by a small electric resistance coil when it is desired to open the valve, and when the coil is deenergized, the disc is cooled by the liquid flowing within the vent passage.

U.S. Pat. No. 4,860,990 discloses a volute chamber having an inflow port is provided at the inlet of an extraction hole of a diaphragm valve. The volute chamber is formed with a lid in a hollow portion of a synthetic resin material member of the diaphragm member. The volute chamber is formed with a cap as volute chamber forming piece at the lower portion of the synthetic resin material member. A small projection is formed at the inlet of the extraction hole and protrudes in the volute chamber. A rib having an inflow port is formed partially at the outer surface of the cap. The spinning speed of the water in the volute chamber and the fluid circulation resistance in the volute chamber become large. The water supply to a back pressure chamber reduces and the closing speed of the diaphragm valve decreases. The water hammering action in the water inlet valve can be mitigated due to the rapid closing operation of the diaphragm valve.

U.S. Pat. No. 5,269,333 discloses a household appliance, solenoid controlled, pilot actuated inlet water valve has a diaphragm insert with a bleed valve that substantially closes when a main valve is open to reduce water and contaminate flow through the bleed passage. The pilot valve outlet extension has openings to reduce vacuum drawn from the outlet into an actuation chamber thereby further reducing water flow through the bleed passage. The bleed passage is internally and externally configured to reduce contamination impairment. An anti-hammer rib or lip is placed on the pilot valve outlet extension upstream of a guide tip which provides less close-fitting surface that may be impaired by contaminates while still dampening valve closing to reduce valve noise and pipe hammer.

A further disadvantage is that the replacement of the water cleaning modules is difficult, because the tube has to be opened in order to change one module. Therefore, filters are normally arranged at a tube part which has a first connection mechanism for the water inlet conduit and a second connection mechanism for the water outlet conduit which are normally arranged at 180° such that the module can be build-in a tube. The water inlet conduit and the water outlet conduit open both in a rectangular flange. The filter is sealingly connectable to this flange such that an inlet conduit of the filter is connected to the inlet conduit of tube part and an outlet conduit of the filter is sealingly connected to the outlet conduit of the filter. This system allows to change the filter without opening the tube system.

### BRIEF SUMMARY OF THE INVENTION

It is one aim of the present invention to reduce the overall length and the required installation space of a water cleaning system and to simplify the mechanism for exchanging pumps, valves and water meters.

The object of the invention is solved by an adapter for a water cleaning system. The adapter comprises a first connection mechanism for connecting a first mechanical part to said adapter, wherein a first connection surface of the adapter is defined by the surface of the adapter enclosed within the first connection mechanism by the first mechanical part, when the first mechanical part is connected to said first connection mechanism. The adapter comprises a second connection mechanism for connecting a second mechanical part to said adapter, wherein a second connection surface of the adapter is defined by the surface of the adapter enclosed within the second connection mechanism by the second mechanical part, when the second mechanical part is connected to said second connection mechanism. The adapter is characterized by a first conduit connecting a first opening in the first connection surface and a second opening in the second connection surface and a second conduit connecting a second opening in the first connection surface and a first opening in the second connection surface.

The object is further solved by a valve, a water meter, a disinfection apparatus or a pump as a mechanical part for a water cleaning system. The mechanical part comprises a connection mechanism for connecting the mechanical part to a water cleaning system, wherein a connection surface of the mechanical part is defined by the surface of the mechanical part enclosed within the connection mechanism by the connected water cleaning system, when the mechanical part is connected to said water cleaning system. The mechanical part comprises further an inlet conduit and an outlet conduit. The mechanical part is characterized in that the inlet conduit and the outlet conduit open within the connection mechanism.

The object is further solved by a water cleaning system. The water cleaning system comprises an above-mentioned adapter and one of a valve, a water meter, a pump, an emergency water outlet and a filter as second mechanical part connected to the second connection mechanism of the adapter, wherein one of the first opening and second opening of the second connection surface of the adapter is connected to the inlet conduit of the second mechanical part and the other of the first opening and second opening is connected to the outlet conduit of the second mechanical part.

The invention uses the concept of the adapter for filter which include inlet and outlet conduit within one connection mechanism also for pumps, water meters and valves. Consequently, the length of the valve, the water meter and the valve is reduced, because the inlet and the outlet don't have to extend in different directions. The adapter having two such connection mechanisms which are connected by two separate conduits allows to connecting for example the pumps, water meters or valves having another connection mechanism than the existing adapter for filters, or have inverse inlet and outlet openings with such tube parts for mounting filters. The adapter also allows to flexibly determine the position of the pumps, water meters or valves connected such that the available space for mounting the water cleaning system can be efficiently used.

The dependent claims refer to further advantageous embodiments of the invention.

In one embodiment, the first opening and second opening of the first connection surface and the first connection mechanism are arranged such that the first conduit of the adapter is sealingly connected to a first conduit of the first mechanical part and the second conduit of the adapter is sealingly connected to a second conduit of the first mechanical part, when the first mechanical part is connected to the first connection mechanism and/or the first opening and second opening of the second connection surface and the second connection mechanism are arranged such that the first conduit of the adapter is sealingly connected to a first conduit of the second mechanical part and the second conduit of the adapter is sealingly connected to a second conduit of the second mechanical part, when the second mechanical part is connected to the second connection mechanism.

In one embodiment, at least one of the connection mechanisms is configured to repeatedly connect and disconnect the at least one of the connection mechanisms with the corresponding mechanical part, wherein the at least one of the connection mechanisms establishes a sealed connection with the corresponding mechanical part, when the at least one of the connection mechanisms is connected with the corresponding mechanical part.

In one embodiment, the second opening is concentrically arranged around the first opening within at least one of the connection surfaces. Preferably but not necessarily, the first opening and the second opening within at least one of the connection surfaces are arranged rotational symmetric around a common axis. This arrangement allows to connect the second mechanical part in any rotation to the second connection mechanism which further increases the flexibility on the arrangement of the mechanical parts.

In one embodiment, the second connection mechanism is a thread. Preferably, the second connection mechanism is a left-hand thread. The thread is a cheap and effective mechanism to sealingly close the first and second conduit connected by the second connection mechanism.

In one embodiment, the first connection mechanism is different from the second connection mechanism. Preferably, one connection mechanism is a flange and the other is a thread. Therefore, the adapter can be used to connect the connection mechanism of filters of the state of the art with other mechanical parts of a water cleaning system like, pumps, water meters, etc.

In one embodiment, the first connection mechanism is a flange. Therefore, the first connection mechanism can easily be mounted on existing flanges for filters which already include an inlet and outlet opening in the flange and the adapter can be used to connect other mechanical parts like valves, pumps and water meters to the flange for filters.

In one embodiment, the first opening and the second opening are arranged within each connection surface in the same way and each connection mechanism is equal. Therefore, the adapter can be arranged in different orientations to different mechanical parts. This increases the flexibility of the adapter, especially if the adapter has more than two connection mechanisms. Then different functions can be achieved by using different combinations of attaching the mechanical parts to the connection mechanisms.

In one embodiment, the second conduit is concentrically arranged around the first conduit.

In one embodiment, the adapter comprises further a third connection mechanism for connecting a third mechanical part to said adapter, wherein a third connection surface of the adapter is defined by the surface of the adapter enclosed within the third connection mechanism by the third mechanical part, when the third mechanical part is connected to said third connection mechanism. The adapter comprises also a third conduit connecting the first opening in the second connection surface and a first opening in the third connection surface and a fourth conduit connecting a second opening in the third connection surface and the second opening in the first connection surface, wherein the third conduit and fourth conduit form the second conduit. This embodiment has a huge advantage over the state of the art, because in small tube range, two modules can be arranged.

In one embodiment, the adapter comprises further a fourth connection mechanism for connecting a fourth mechanical part to said adapter, wherein a fourth connection surface of the adapter is defined by the surface of the adapter enclosed within the fourth connection mechanism by the fourth mechanical part, when the fourth mechanical part is connected to said fourth connection mechanism. The adapter also comprises a fifth conduit connecting the first opening in the second connection surface and a first opening in the fourth connection surface and a sixth conduit connecting a second opening in the fourth connection surface and the second opening in the first connection surface. This embodiment has a huge advantage over the state of the art, because in small tube range, three mechanical parts can be arranged. In addition, the third and fourth connection mechanisms are connected in parallel to the first and second connection mechanism. This allows for example to arrange within a small space one pre-filter which has a higher throughput at the second connection mechanism and two finer filter at the third and fourth connection mechanisms such that the same throughput of the pre-filter can be achieved by the two finer filters connected in parallel.

In one embodiment, the adapter comprises further a fourth connection mechanism for connecting a fourth mechanical part to said adapter, wherein a fourth connection surface of the adapter is defined by the surface of the adapter enclosed within the fourth connection mechanism by the fourth mechanical part, when the fourth mechanical part is connected to said fourth connection mechanism. The adapter comprises also a fifth conduit connecting the first opening in the second connection surface and a second opening in the fourth connection surface and a sixth conduit connecting a first opening in the fourth connection surface and the first opening in the third connection surface, wherein the fifth conduit and sixth conduit form the third conduit. This embodiment has a huge advantage over the state of the art, because in small tube range, three mechanical parts can be arranged. In addition, the first, second, third and fourth connection mechanisms are connected in series. This allows to arranging three mechanical parts which in the state of the art had to be arranged along a long piece of tube. If the first and second opening within all connection mechanisms are arranged equally and the connection mechanism are equal, the described connection of first to second and second to first opening in three couples of connection mechanisms and one inverse connection of the first to first and second to second opening in one couple of connection mechanisms has the advantage that the function of the adapter can be changed according to which connection mechanism is chosen to be connected to the tube side.

In one embodiment, the adapter with four connection mechanisms is formed such that the axes of the four connection mechanisms build a cross.

In one embodiment, the adapter further comprises at least one mounting mechanism connected to the at least one of the conduits for mounting a pressure measuring device for measuring the pressure in the conduit connected. This has further the advantage that also the pressure measuring devices are included in the adapter and the size of the water cleaning system can be further reduced.

In one embodiment, the adapter further comprises a first mounting mechanism connected to the first conduit for mounting a pressure measuring device for measuring the pressure in the first conduit and/or a second mounting mechanism connected to the first conduit for mounting a pressure measuring device for measuring the pressure in the first conduit.

In one embodiment, the adapter further comprises a third mounting mechanism connected to the third conduit for mounting a pressure measuring device for measuring the pressure in the third conduit and a fourth mounting mechanism connected to the fourth conduit for mounting a pressure measuring device for measuring the pressure in the fourth conduit, wherein the third mounting mechanism or the fourth mounting mechanism form the second mounting mechanism.

In one embodiment, the adapter further comprises a fifth mounting mechanism connected to the fifth conduit for mounting a pressure measuring means for measuring the pressure in the fifth conduit and a sixth mounting mechanism connected to the sixth conduit for mounting a pressure measuring device for measuring the pressure in the sixth conduit, wherein the fifth mounting mechanism or the sixth mounting mechanism form the third mounting mechanism.

In one embodiment, the adapter further comprises at least a pressure measuring means connected to the at least one mounting mechanism.

In one embodiment of the water cleaning system, the connection mechanism of the second mechanical part and the second connection mechanism are threads, one left-handed and the other right-handed, and the connection mechanism of the second mechanical part and the second connection mechanism are connected by a ring with two opposed-handed threads. This has the advantage that a good connection is provided between the second connection mechanism and the second mechanical part by threads and nevertheless, only the ring has to be turned in order to fix the second mechanical part to the second connection mechanism.

In one embodiment, the water cleaning system comprises further a tube part with a first connection mechanism for connecting another tube, wherein a first conduit opens within the first connection mechanism, a second connection mechanism for connecting another tube, wherein a second conduit opens within the second connection mechanism, and a third connection mechanism connected to the first connection mechanism of the adapter, wherein a connection surface of the tube part is defined by the surface of the tube part enclosed within the third connection mechanism by the adapter and wherein the first conduit of the adapter is connected within the connection surface to the first conduit of the tube part and the second conduit of the adapter is connected within the connection surface to the second conduit of the tube part.

In one embodiment the water cleaning system, the third connection mechanism of the tube part is a flange and the other connection mechanism of the adapter is not a flange and a further adapter is arranged between the third connection mechanism of the tube part and the other connection mechanism of the adapter. This allows to connect the present system to a connection mechanism for filters.

In one embodiment the water cleaning system, a further adapter is connected between the one connection mechanism and the mechanical part connected to the one connection mechanism closing the first or second opening of the one connection mechanism of the adapter. Therefore, even state of the art connection mechanisms with only one opening can be arranged at the adapter of the invention. An example is the before mentioned water outlet.

All embodiments of the invention is common that they have at least two connection mechanisms which enclose each two openings, wherein each opening is connected to a conduit which connects the corresponding opening with another opening of another connection mechanism. This inventive concept has the huge advantage that the inflow and outflow of a functional mechanical part like a valve, a water meter or a pump can be connected to a pipe system with only two connection mechanisms. In addition, this concept allows to arrange a plurality of functional mechanical parts at one multi adapter, because only one connection mechanism is needed for guiding the inflow and outflow of the pipe system in the multi adapter. At each second connection mechanism one functional mechanical part can be connected by simultaneously connecting the inflow and the outflow opening. The guidance of the water flow within the multi adapter can designed as needed, e.g. the connection mechanisms can be connected in series, i.e. one opening of one connection mechanism is connected with an opening of only one other connection mechanism, in parallel, i.e. one opening of one connection mechanism is connected with one opening of at least two connection mechanism, in a combination of parallel and serial or even in parallel with different throughputs.

### BRIEF DESCRIPTION OF THE DRAWINGS

The invention will be better understood with the aid of the description of an embodiment given by way of example and illustrated by the figures, in which:

FIG. 1 shows a view of the general principal of the inventive valve body;

FIG. 2a, b shows a first embodiment of the inventive valve body illustrated in two views, wherein FIG. 2a is a cut through the FIG. 2b;

FIG. 3a, b shows a second embodiment of the inventive valve body illustrated in two views, wherein FIG. 3a is a cut through the FIG. 3b;

FIG. 4a, b shows a third embodiment of the inventive valve body illustrated in two views, wherein FIG. 4a is a cut through the FIG. 4b;

FIG. 5a, b shows a fourth embodiment of the inventive valve body illustrated in two views, wherein FIG. 5a is a cut through the FIG. 5b;

FIG. 6a, b shows a fifth embodiment of the inventive valve body illustrated in two views, wherein FIG. 6a is a cut through the FIG. 6b;

FIG. 7a, b shows a sixth embodiment of the inventive valve body illustrated in two views, wherein FIG. 7a is a cut through the FIG. 7b; and

FIG. 8a, b shows one example of a multi-adapter illustrated in two views, wherein FIG. 8a is a perspective of the top view FIG. 8b.

FIG. 9a, b shows another example of a multi-adapter illustrated in two views, wherein FIG. 8a is a perspective of the top view FIG. 8b.

FIG. 10a, b shows an example of a water cleaning system comprising a valve, a water meter, an emergency water outlet, an adapter, a multi-adapter and a tube part illustrated in two views, wherein FIG. 10a is a perspective of the top view FIG. 10b.

### DETAILED DESCRIPTION OF POSSIBLE EMBODIMENTS OF THE INVENTION

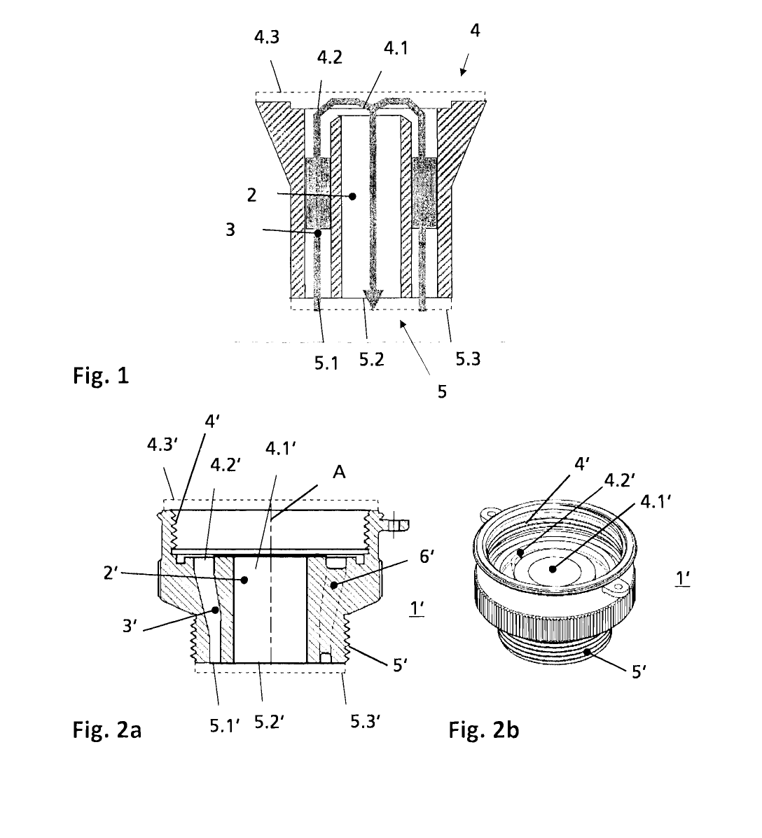

FIG. 1 shows a view of the general principal of the adapter 1 according to one embodiment of the invention. The adapter comprises a first conduit 2 and a second conduit 3. In this embodiment the second conduit is concentrically arranged around the first conduit 2. Arrows show the fluid direction of the fluid going through the adapter 1. As seen in these embodiments the outer ring conduit 3 is herein used as inflow and the core conduit 2 is used as outflow. This might, however, be different according to the use of the adapter 1, i.e. the outer ring conduit 2 might be used as outflow and the core conduit 2 is used as inflow. The adapter 1 shows especially that the outer ring conduit 3 and the core conduit 2 are coaxial around the same axis A and not as in the prior art solutions 180 dgr opposite. The adapter 1 shows a first connection mechanism 4 and a second connection mechanism 5 both configured to repeatedly connect and disconnect a mechanical part. The first and/or second connection mechanism 4 and/or 5 is further configured that the repeated connection and disconnection is possible without damaging the connection mechanisms 4 and/or 5. The first and/or second connection mechanisms 4 and/or 5 are/is configured such that a sealed connection can be created with a mechanical part which guarantees even after repeated connection and disconnection a connection not leaking a fluid. The first connection mechanism 4 defines a surface which will be called in the following the first connection surface 4.3. The second connection mechanism 5 defines a surface within the second connection mechanism 5 which will be called in the following the second connection surface 5.3. Such a connection surface is defined by the surface of the adapter 1 which is leak-proofed enclosed or covered by the mechanical part, when the mechanical part is connected to the connection mechanism. The first conduit 2 opens in this embodiment in a central opening 4.1 in the first connection surface 4.3 (as first opening of the first connection surface according to claim 1) and in a central opening 5.2 in the second connection surface 5.3 (as second opening of the second connection surface according to claim 1). The second conduit 3 opens in this embodiment in an outer ring opening 4.2 in the first connection surface 4.3 (as second opening of the first connection surface according to claim 1) and in an outer ring opening 5.1 in the second connection surface 5.3 (as first opening of the second connection surface according to claim 1). In this embodiment, the first conduit 2 opens only in the central openings 4.1 and 5.2 of the first and second connection surface 4.3 and 5.3 and the second conduit 3 opens only in the outer ring openings 4.2 and 5.1 of the first and second connection surface 4.3 and 5.3 such that both conduits 2 and 3 provide a direct connection between the mentioned openings, respectively. The central opening 4.1 can consist of one, two, three or any plurality of sub-openings, wherein each of the sub-openings is arranged in the first connection surface 4.3, 5.3 and is connected to the first conduit 2. The same holds analogue for the outer ring opening 4.2 of the first connection surface 4.3 or for the openings 5.1 and 5.2 of the second connection surface 5.3. The central and outer ring openings 4.1 and 4.2 or 5.2 and 5.1 are not restricted to the shown forms of concentrically arranged rings, but can have any form configured to enter fully in the first or second connection surface 4.3 or 5.3 and configured to allow the separate connection of the central and outer ring opening 4.1 and 4.2 or 5.1 and 5.2 with the mechanical part. In a preferred embodiment, the outer ring opening 4.2 is preferably arranged around the central opening 4.1 in the first connection surface 4.3 (e.g. surface defined by a flange or one cross-section of the thread). Preferably, the central opening 4.1 or 5.2 has the form of a circle and the second opening 4.2 or 5.1 has the form of a ring, wherein the outer ring border of the opening forms as well a circle, which preferably has the same center point or at least a center point being on the same axis. Preferably, the central and outer ring opening surfaces are substantially or exactly parallel. Substantially parallel means that a deviation of five degrees, preferably two degrees is allowed. Preferably, the connection mechanisms 4 and 5 have the form of a cylinder, wherein the cylinder ground surface comprises the openings and the skin surface a thread. The cylinder can even be hollow, such that the thread is arranged on the inner side of the skin surface. In this example, the first and second conduits 2 and 3 have no connections between them except over the central and outer ring opening of one connection surface. As fluid any gas or liquid can be used. In an advantageous embodiment, this adapter 1 is used in water cleaning or treatment system and water is used as fluid.

FIG. 2a, b to 7a, b show different embodiments of the adapter 1. FIG. 2 shows an adapter 1′ according to a first embodiment, wherein FIG. 2a is a cut through, the FIG. 2b is a three-dimensional view of the adapter 1′. The adapter 1′ of FIG. 2a shows an inner thread 4′ as a first connection mechanism to which a first mechanical part (not shown in this Figure) can be connected on a first side to said adapter 1′. The thread 4′ has the advantage to distribute the pressure of the first mechanical part to said adapter 1′. The first mechanical part connects both conduits 2′, 3′ by applying a certain function or to provide a fluid inlet and a fluid outlet of the adapter 1′ through the first mechanical part. In the case of a valve as a first mechanical part, a valve mechanism would depending on the valve functioning connect the first and second conduit 2′ and 3′ and let fluid through or disconnect the first and second conduit 2′ and 3′ for closing the connection. The first mechanical part can be also a water meter which receives the fluid from one of the conduits 2′ and 3′ and guides the fluid in the other of the conduits 2′ and 3′ while measuring the amount of fluid passed. In the case of a pump as first mechanical part, the pump would receive the fluid from one of the conduits 2′ and 3′ and pump the fluid in the other of the conduits 2′ and 3′. In any case, the first mechanical part has an inlet conduit and an outlet conduit which are sealingly connected to the first conduit 2′ and second conduit 3′, respectively or vice versa by connecting the first mechanical part with the first connection mechanism 4′. In this embodiment, the inner core ring separating the core conduit 2′ from the outer ring conduit 3′ is connected to the outer shelf of the outer ring conduit 3′ by a connection part 6′. However, other more extensive connections might be possible.

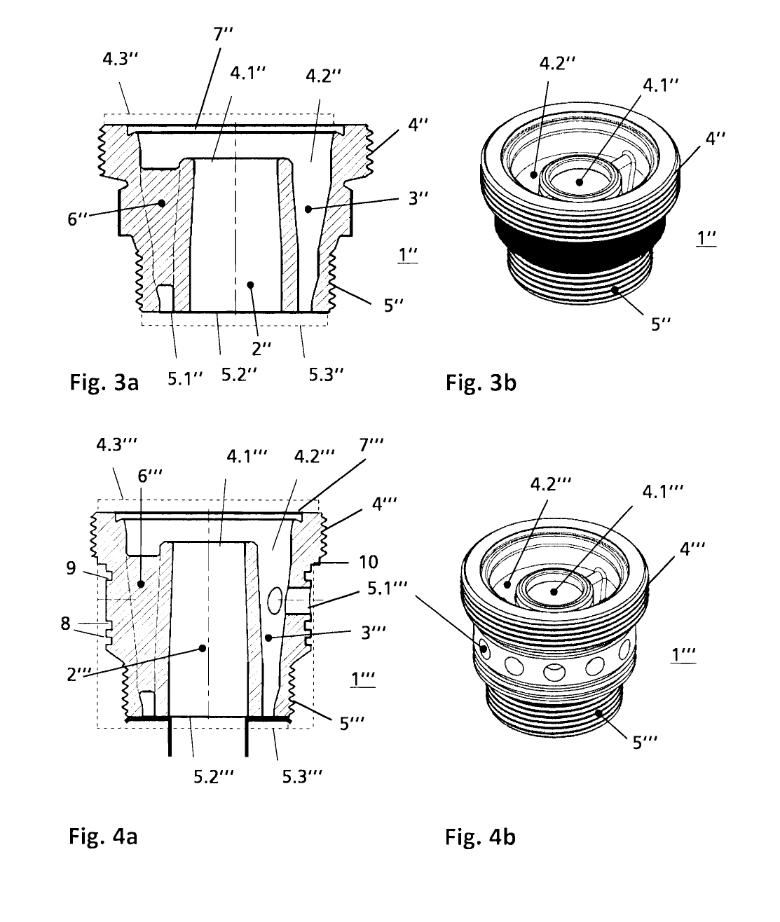

FIG. 3 shows an adapter 1″ according to a second embodiment, wherein FIG. 3a is a cut through, the FIG. 3b is a three-dimensional view of the adapter 1″. The embodiment of FIG. 3a, b cannot only be used as an adapter to a full mechanical part, but could be used for building already a part of the mechanical part. E.g. the adapter 1″ could be used as valve body. Additionally, the upper part shows an example of a recess 7″ for fixing the membrane. The valve consists of the adapter 1″ as valve body with first and second conduits 2″ and 3″ as inflow and outflow of the valve and the arrangement for the valve mechanic as first mechanical part (not shown). The actuator of the valve can be manually, pneumatic, electromagnetic, etc. Any valve known in the prior art can be used. In the adapter 1″ can be integrated the servo lines which goes up to the valve mechanism.

FIG. 4 shows an adapter 1′″ according to a third embodiment, wherein FIG. 4a is a cut through, the FIG. 4b is a three-dimensional view of the adapter 1′″. The embodiment of FIG. 4a, b can e.g. be used for a valve mechanic. In this embodiment, the outer ring conduit 3′″ opens not only on the flat side of the cylinder, but also in side holes 5.1′″. The side holes 5.1′″ connect the outer ring conduit 3′″ with the outer shelf of the adapter 1′″. In this embodiment, the thread 5′″ is arranged at the end of the cylinder building the second connection mechanism 5′″. The outer shell of the cylinder increases in diameter after the thread 5′″. The cylinder part with the increased diameter comprises side holes 5.1′″ as first opening connected with the second conduit 3′″. In order to sealingly and independently connecting a first and a second conduit of the second mechanical part to the first conduit 2 and second conduit 3, respectively, the cylinder part with the increased diameter comprises at least one recess 8 between the side holes 5.1′″. The at least one recess 8 is configured to receive a ring seal for each recess. This cylinder part with the increased diameter ends on the side opposing the thread 5′″ at the thread 4′″. The thread 4′″ forms a first connection mechanism which is formed of another cylinder with further increased diameter. The cylinder part with the increased diameter between the thread 4′″ and thread 5′″ comprises further at least one recess 9 between the side holes 5.1′″ and the thread 4′″ which is configured to receive a sealing. The corresponding connection mechanism of the second mechanical part has a hollow cylinder which is open at least on one side. The diameter of this hollow cylinder at the open side corresponds to the diameter of the cylinder part of the adapter 1′″ in FIG. 4a, b between the threads 4′″ and 5′″. The hollow cylinder of the second mechanical part comprises on the opposite side of the opening an inner thread, inversely corresponding to the thread 5′″. The recesses 8 and 9 of the adapter 1′″ are provided with seals (not shown). In order to connect the second connection mechanism of the adapter 1′″ in FIG. 4 a, b with the second mechanical part, the hollow cylinder of the second mechanical part is imposed to the second connection mechanism of the adapter 1′″ and screwed until the end of the hollow cylinder of the second mechanical part fits tightly with the step 8 between the part of the cylinder of the second connection mechanism with increased diameter and the thread 4′″ of the first connection mechanism. Therefore, the second connection surface 5.3′″ in FIG. 4a, b comprises the outer shell of the cylinder part with the increased diameter between both threads 4′″ and 5′″ and the ground surface of the cylinder of the second connection mechanism.

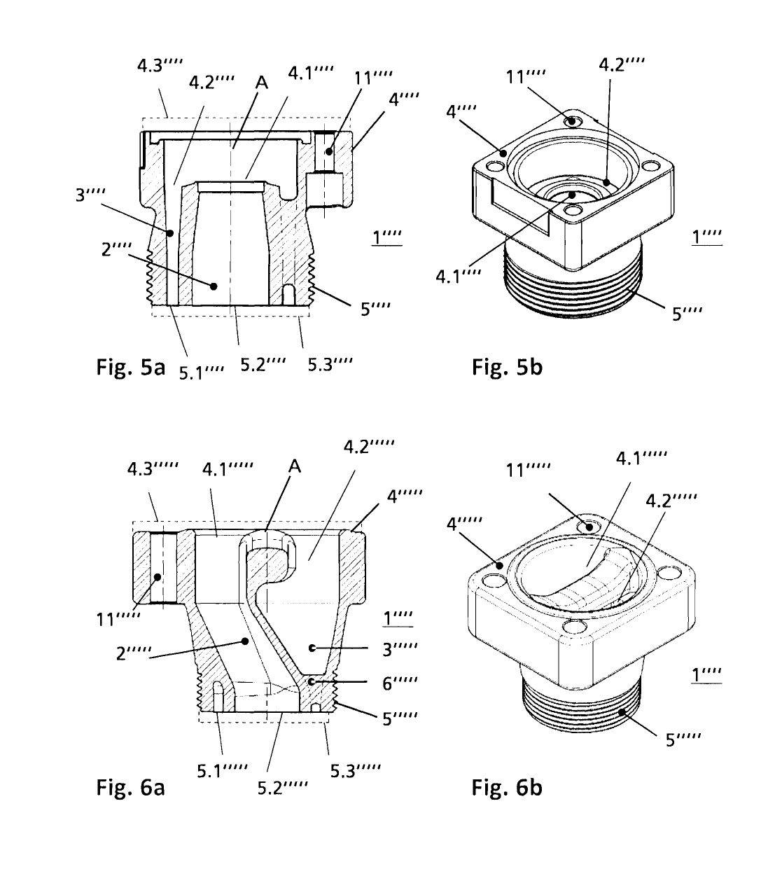

FIG. 5 shows an adapter 1″″ according to a fourth embodiment, wherein FIG. 5a is a cut through, the FIG. 5b is a three-dimensional view of the adapter 1″″. The embodiment of FIG. 5a, b can e.g. be used for a valve mechanic. In this embodiment a flange 4″″ having holes 11″″ is provided to be connected to a valve, water meter, pump, a tube part, etc. Although not shown in the drawings, a flange could as well be provided to the other instead of outer thread 5″″.

FIG. 6 shows an adapter 1′″″ according to a fifth embodiment, wherein FIG. 6a is a cut through, the FIG. 6b is a three-dimensional view of the adapter 1′″″. The embodiment of FIG. 6a, b can e.g. be used for a valve mechanic. In this embodiment, a flange 4′″″ as first connection mechanic having holes 11′″″ is provided to be connected to a valve mechanism which presses a diaphragm to the adapter 1′″″ as valve body balk to interrupt the flow. Although not shown in the drawings, a flange could as well be provided to the other side instead of outer thread 5′″″ as second connection mechanism.

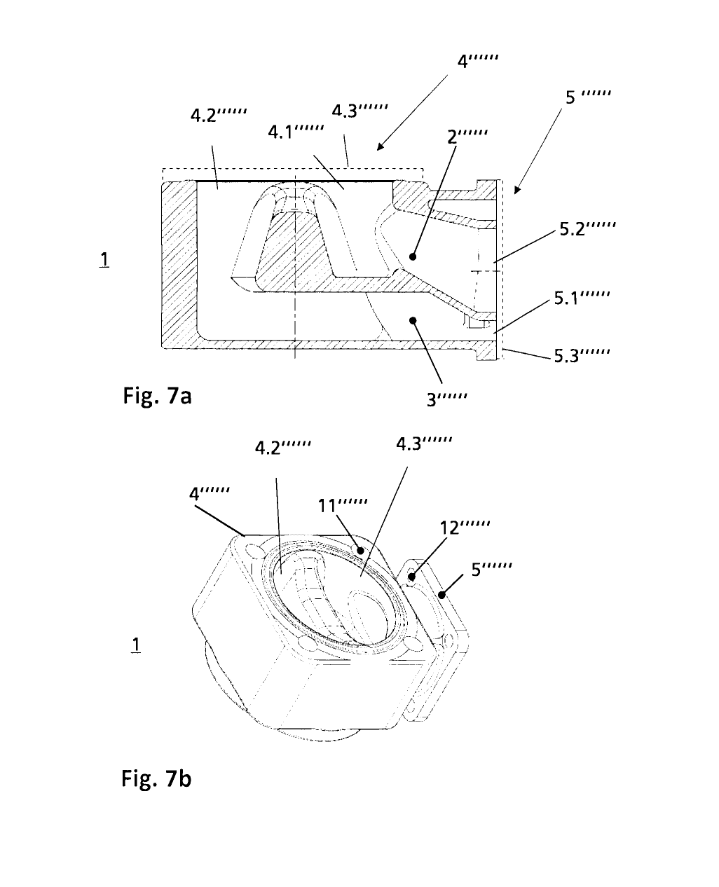

FIG. 7 shows an adapter 1″″″ according to a sixth embodiment, wherein FIG. 7a is a cut through, the FIG. 7b is a three-dimensional view of the adapter 1″″″. The embodiment of FIG. 7a, b can e.g. be used for a valve mechanic. In this embodiment, a first flange 4″″″ as first connection mechanic having holes 11″″″ is provided to be connected to valve mechanism which presses a diaphragm to the adapter 1″″″ as valve body balk to interrupt the flow. A second flange 5″″″ as a second connection mechanism with holes 12″″″ with fixation means like screws is provided for connecting the adapter 1″″″ to a second mechanical part. Here the adapter 1″″″ has the two connection mechanism whose longitudinal axes are arranged not 180° to each other but only 90°. This could help to further save space in some special cases, when installing the water cleaning system.

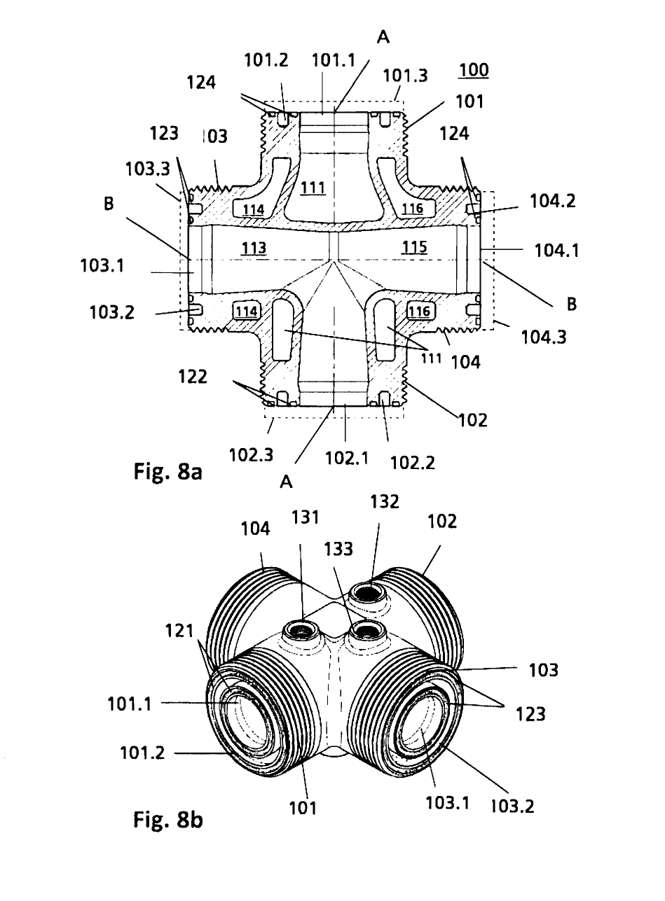

FIG. 8 shows a multi-adapter 100 according to one embodiment of the invention, wherein FIG. 8a is a cut through, the FIG. 8b is a three-dimensional view of the multi-adapter 100. The multi-adapter 100 comprises a first connection mechanism 101, a second connection mechanism 102, a third connection mechanism 103, a fourth connection mechanism 104, a first conduit 111, a second conduit 113, a third conduit 115, a fourth conduit 114, a fifth conduit 116, first recesses 121, second recesses 122, third recesses 123, fourth recesses 124, a first mounting mechanism 131, a second mounting mechanism 132, a third mounting mechanism.

The first to fourth connection mechanism 101 to 104 are formed in four directions of the multi-adapter 100. The first and second connection mechanisms 101 and 102 are arranged along a first axis A in opposing directions. The third and fourth connection mechanisms 103 and 104 are arranged along a second axis B in opposing directions. As shown in FIG. 8b, the first axis A is arranged rectangular to the second axis B. In this embodiment, the four connection mechanisms 101 to 104 form a cylinder whose cylinder axis correspond to the axis A or B, respectively. The outer shelf of the cylinder forms at the end of the cylinder an outer thread such that a mechanical part or an adapter 1 as described before can be connected to each of the connection mechanisms 101 to 104. Preferably, the mechanical part or the adapter 1 has also a connection mechanism which is formed out also as a cylinder with the same diameter. This cylinder comprises an opposed handed outer thread. The two connection mechanisms can then be connected by the use of a ring having corresponding opposed handed inner threads such that the connection mechanism of the multi-adapter 100 and the connection mechanism of the mechanical part can be connected without any rotation of the multi-adapter 100 and the mechanical part/adapter 1, but only by rotating the ring. When a mechanical part is connected to the first connection mechanism 101, a first connection surface 101.3 is covered by the mechanical part. In other words, the multi-adapter 100 and the mechanical part enclose the first connection surface 101.3. In the same way, the second connection surface 102.3, the third connection surface 103.3 and the fourth connection surface 104.3 are defined within the second connection mechanism 102, the third connection mechanism 103 and the fourth connection mechanism 104, respectively.

The first conduit 111 connects a first opening 101.1 of the first connection surface 101.3 and a second opening 102.2 of the second connection surface 102.3. The second conduit 113 connects a first opening 102.1 of the second connection surface 102.3 and a second opening 103.2 of the third connection surface 103.3. The third conduit 115 connects the first opening 102.1 of the second connection surface 102.3 and a second opening 104.2 of the fourth connection surface 104.3. The fourth conduit 114 connects a second opening 103.2 of the third connection surface 103.3 and a second opening 101.2 of the first connection surface 101.3. The fifth conduit 116 connects a second opening 104.2 of the fourth connection surface 104.3 and the second opening 101.2 of the first connection surface 101.3. Therefore, a water flow guided in the first opening 101.1 of the first connection surface 101.3 flows to the second opening 102.2 of the second connection surface. If a mechanical part is connected to the second connection mechanism 102, the water flow enters through the second opening 102.2 the mechanical part and returns over the first opening 102.1 in the multi-adapter 100. Since the first opening 102.1 is connected over the second and third conduit 113 and 115 to the first opening 103.1 and 104.1, the water flow is split up and flows to the mechanical parts connected to the third and fourth connection mechanisms 103 and 104 and flows back through the second openings 103.2 and 104.2 in the fourth and fifth conduit 114 and 116, where the two water flows join again in the second opening 101.2 of the first connection surface 101.3. Therefore, such a multi-adapter 100 is well adapted for connecting a pre-filter with an higher throughput at the second connection mechanism and two finer filters with a low throughput at the third and fourth connection mechanisms 103 and 104 such that the throughput in the multi-adapter 100 is not reduced by the finer filter since the fine filter have to handle only half of the water flow. However, there are a large number of other applications of this multi-adapter 100. For example, a tube part as a water source could be connected to the first connection mechanism 101, wherein the water enters through the first opening 101.1. The second connection mechanism 102 could be connected to a water meter. The third and fourth connection mechanism 103 and 104 could be connected to a filter and a water outlet. The water outlet could be used as an outlet for unfiltered water e.g. for the use in the garden and the water going out of the multi-adapter 100 at the first connection mechanism 101 through the second opening 101.2 back in the tube is always filtered, because the water outlet closes the second opening of the connection mechanism 103 or 104 connected to the water outlet. This could be done directly by a water outlet adapted to be connected to the first or second connection mechanism 103 or 104 or an additional adapter with two connection mechanisms, one adapted to be connected to the multi-adapter 100 and another adapted to connect a water outlet of the state of the art. The adapter closes the second opening (or in another embodiment the first opening). In another embodiment, instead of the water meter a pump could be mounted at the second connection mechanism 102. This is especially interesting if there is no natural water pressure from the water pipe, e.g. because the water is pumped out of a water container.

As shown in FIG. 8b, the first opening 101.1 has the form of a circle around the axis A. The second opening 101.1 has the form of a ring around the first opening with the same center point. Since the thread of the connection mechanism 101 is also arranged around the first axis A, the mechanical part can be mounted in any orientation to the first connection mechanism such that the first opening 101.1 is connected to a first conduit of the mechanical part and the second opening 101.2 is connected to a second conduit of the mechanical part. A recess 121 is arranged in the form of a circle around the axis A between the first opening 101.1 and the second opening 101.2. The recess 121 comprises a seal (not shown) which prevents a leakage or flow of fluid from the first opening 101.1 in the second opening 101.2, when the connection mechanism of the mechanical part is connected to the first connection mechanism 101 and presses on the seal in the recess 121. A further recess 121 is arranged in the form of a circle around the axis A between the second opening 101.2 and the thread. The further recess 121 comprises a seal (not shown) which prevents a leakage of fluid from the second opening 101.1 out of the multi-adapter 100, when the connection mechanism of the mechanical part is connected to the first connection mechanism 101 and presses on the seal in the recess 121. Preferably, the first opening 101.1 has the same or substantially the same opening surface than the second opening 101.2 in order to provide the same throughput through the first and second opening 101.1 and 101.2. The first opening 102.1 and the second opening 102.2 and the recesses 122 of the second connection mechanism 102 are arranged in the same way. The first openings 103.1, 104.1 and the second openings 103.2, 104.2 and the recesses 123 and 124 of the third and fourth connection mechanisms 103 and 104 are arranged in the same way around the axis B.

The second and the third conduit 113 and 115 have a first common part which is arranged around the axis A and forms a bifurcation in the second part of the second conduit 113 and the second part of the third conduit 115. The second parts of the second and third conduit 113 and 115 are arranged along the second axis B such that the second and third conduit 113 open in the first opening 103.1 and 104.1, respectively. That is that the first part of the second and third conduit 113 and 115 turns −90° and +90° to form the second part of the second and third conduit 113 and 115, respectively. The bifurcation of the second and third conduit 113 and 115 is at the crossing point of the first axis A and the second axis B. The first conduit 111 forms a bifurcation above and/or below the second parts of the second and third conduit 113 and 115. The first conduit 111 reunites in an outer ring conduit around the first part of the second and third conduit 113 and 115. The first conduit 111 ends and opens in the second opening 102.2. The fourth conduit 114 and the fifth conduit 116 form a first common part in the form of an outer ring conduit around the first conduit 111 in the region of the first connection mechanism 101. The first common part of the fourth and fifth conduit 114 and 116 bifurcates in a second part of the fourth and fifth conduit 114 and 116. The second part of the fourth conduit 114 is formed as an outer ring conduit around the second part of the second conduit 113 in the region of the third connection mechanism 103 opening in the second opening 103.2. The second part of the fifth conduit 116 is formed as an outer ring conduit around the second part of the third conduit 115 in the region of the fourth connection mechanism 104 opening in the second opening 104.2.

As shown in FIG. 8b, the multi-adapter comprises a first mounting mechanism 131, a second mounting mechanism 132 and a third mounting mechanism 133. Preferably, the mounting mechanisms 131, 132 and 133 are formed out of a hole connected to one of the conduits with an inner thread. A pressure measuring device (not shown), e.g. a pressure gauge, can be screwed in the mounting mechanisms 131, 132, 133 in order to measure the pressure in the connected conduit. The first mounting mechanism 131 is connected with the first conduit 111. The second mounting mechanism 132 is connected to the second and/or third conduit 113 and/or 115. The third mounting mechanism 133 is connected to the fourth and/or fifth conduit 114 and/or 116.

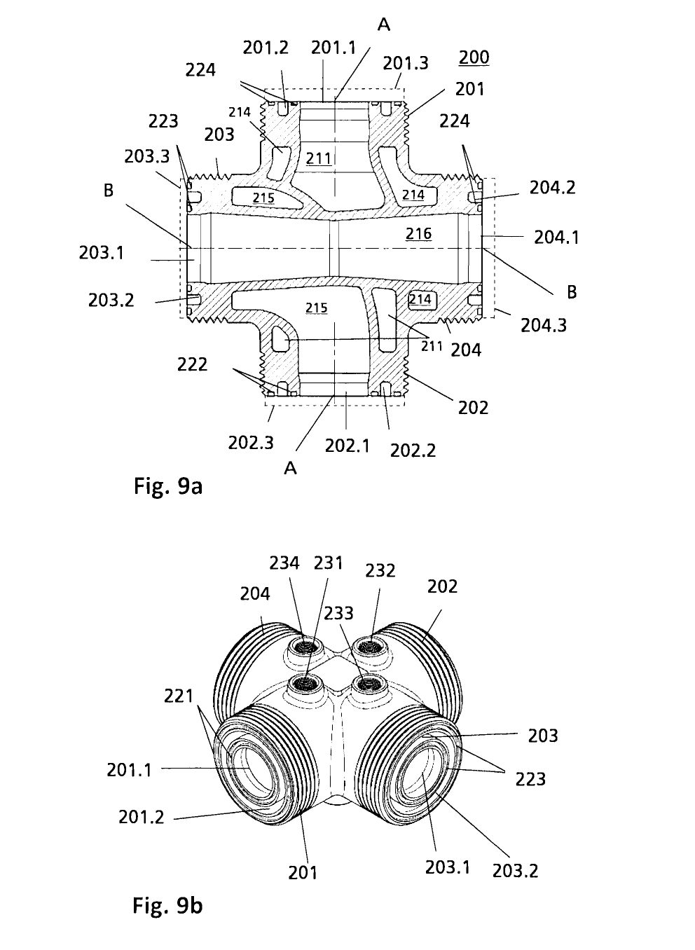

FIG. 9 shows a multi-adapter 200 according to another embodiment of the invention, wherein FIG. 9a is a cut through, the FIG. 9b is a three-dimensional view of the multi-adapter 200. The multi-adapter 200 comprises a first connection mechanism 201, a second connection mechanism 202, a third connection mechanism 203, a fourth connection mechanism 204, a first conduit 211, a second conduit 215, a third conduit 216, a fourth conduit 214, first recesses 221, second recesses 222, third recesses 223, fourth recesses 224, a first mounting mechanism 131, a second mounting mechanism 132, a third mounting mechanism 133, a fourth mounting mechanism 134.

The first to fourth connection mechanisms 201 to 204 are formed in four directions of the multi-adapter 200. The first and second connection mechanisms 201 and 202 are arranged along a first axis A in opposing directions. The third and fourth connection mechanisms 203 and 204 are arranged along a second axis B in opposing directions. As shown in FIG. 8b, the first axis A is arranged rectangular to the second axis B. In this embodiment, each of the four connection mechanisms 201 to 204 form a cylinder whose cylinder axis correspond to the axis A or B, respectively. The outer shelf of the cylinder forms at the end of the cylinder an outer thread such that a mechanical part or an adapter 1 as described before can be connected to each of the connection mechanisms 201 to 204. Preferably, the mechanical part or the adapter 1 has also a connection mechanism which is formed out also as a cylinder with the same diameter. This cylinder comprises an opposed handed outer thread in comparison to the thread of the connection mechanism 201 to 204. The two connection mechanisms of the multi-adapter 200 and the mechanical part can then be connected by the use of a ring having corresponding opposed handed inner threads such that the connection mechanism of the multi-adapter 200 and the connection mechanism of the mechanical part can be connected without any rotation of the multi-adapter 200 and the mechanical part, but only by rotating the ring. When a mechanical part is connected to the first connection mechanism 201, a first connection surface 201.3 is covered by the mechanical part. In other words, the multi-adapter 200 and the mechanical part enclose the first connection surface 201.3. In the same way, the second connection surface 202.3, the third connection surface 203.3 and the fourth connection surface 204.3 are defined within the second connection mechanism 202, the third connection mechanism 203 and the fourth connection mechanism 204, respectively.

The first conduit 211 connects a first opening 201.1 of the first connection surface 2201.3 and a second opening 202.2 of the second connection surface 202.3. The second conduit 215 connects a first opening 202.1 of the second connection surface 202.3 and a second opening 203.2 of the third connection surface 203.3. The third conduit 216 connects a first opening 203.1 of the third connection surface 203.3 and a first opening 204.2 of the fourth connection surface 204.3. The fourth conduit 214 connects a second opening 203.2 of the third connection surface 203.3 and a second opening 201.2 of the first connection surface 201.3. Therefore, a water flow guided in the first opening 201.1 of the first connection surface 201.3 flows to the second opening 202.2 of the second connection surface 202.3. If a mechanical part is connected to the second connection mechanism 202, the water flow enters through the second opening 202.2 the mechanical part and returns over the first opening 202.1 in the multi-adapter 200. The water flows through the second conduit 215 to the second opening 203.2 of the third connection mechanism 203. The water flows in an inlet conduit of a mechanical part connected to the second opening 203.2 and flows back through the first opening 203.1 in the third conduit 215. In a similar way the water enters a mechanical part connected at the fourth connection mechanism 204 over the first opening 204.1 and returns back in the multi-adapter 200 over the second opening 204.2. Then, the water enters the fourth conduit 214 and exits the multi-adapter 200 finally at the second opening 201.2 of the first connection mechanism 201. The multi-adapter 200 connects the first and second openings of the four connection mechanisms 201 to 204 in series. This allows the connection of three mechanical parts of a water cleaning system in series at almost a fourth of the space needed as in the state of the art. In addition, if the fluid is introduced in any first opening arranged in the center of the corresponding connection mechanism 201, 202, 203 or 204, there are two further connection mechanisms which provide a fluid outlet in the second connection mechanism and one other connection mechanism which provides a fluid outlet in the first opening. Depending on the choice of the connection mechanism 201, 202, 203 or 204 as a fluid inlet from the pipe system, the connection mechanism with the water outlets in the second openings to the mechanical parts and the connection mechanism with the fluid outlet in the first opening to the mechanical part are arranged at different sides. This increases the flexibility of the multi-adapter 200 which can be used for mechanical parts which necessitates the water inlet in the center and for mechanical parts which necessitates the fluid inlet in the outer ring.

As shown in FIG. 9b, the first opening 201.1 has the form of a circle around the axis A. The second opening 201.1 has the form of a ring around the first opening with the same center point. Since the thread of the connection mechanism 201 is also arranged around the first axis A, the mechanical part can be mounted in any orientation to the first connection mechanism 201 such that the first opening 201.1 is connected to a first conduit of the mechanical part and the second opening 201.2 is connected to a second conduit of the mechanical part. A recess 221 is arranged in the form of a circle around the axis A between the first opening 201.1 and the second opening 201.2. The recess 221 comprises a seal (not shown) which prevents a leakage or flow of fluid from the first opening 201.1 in the second opening 201.2, when the connection mechanism of the mechanical part is connected to the first connection mechanism 201 and presses on the seal in the recess 221. A further recess 221 is arranged in the form of a circle around the axis A between the second opening 201.2 and the thread. The further recess 221 comprises a seal (not shown) which prevents a leakage of fluid from the second opening 201.1 out of the multi-adapter 200, when the connection mechanism of the mechanical part is connected to the first connection mechanism 201 and presses on the seal in the recess 221. Preferably, the first opening 201.1 has the same or substantially the same amount of opening surface than the second opening 201.2 in order to provide the same throughput through the first and second opening 201.1 and 201.2. The first opening 202.1 and the second opening 202.2 and the recesses 222 of the second connection mechanism 202 are arranged in the same way. The first openings 203.1, 204.1 and the second openings 203.2, 204.2 and the recesses 223 and 224 of the third and fourth connection mechanisms 203 and 204 are arranged in the same way around the axis B.

The third conduit 216 is arranged around the axis b and builds an inner core conduit. The first conduit 211 forms a bifurcation above and below the third conduit 216. The first conduit 211 reunites in an outer ring conduit around the part of the second conduit 215 being in the cylinder of the second connection mechanism 202. The first conduit 211 ends and opens in the second opening 202.2. The second conduit 215 is arranged in the part being in the cylinder of the second connection mechanism 202 around the axis A as an inner core conduit. The second conduit 202 turns in the direction of the cylinder of the third connection mechanism 203 without connecting to the first, third or fourth conduit 211, 216 or 214. The part of the second conduit 215 in the cylinder of the third connection mechanism 203 extends around the third conduit 216 to form an outer ring conduit around the axis B. The fourth conduit 214 forms a first common part in the form of an outer ring conduit around the first conduit 211 in the region of the first connection mechanism 201. The second part of the fourth conduit 214 is formed as an outer ring conduit around the second part of the third conduit 216 in the region of the third connection mechanism 203 opening in the second opening 203.2.

As shown in FIG. 9b, the multi-adapter comprises a first mounting mechanism 231, a second mounting mechanism 232, a third mounting mechanism 233 and a fourth mounting mechanism 234. Preferably, the mounting mechanisms 231, 232, 233 and 234 are each formed out of a hole connected to one of the conduits. The hole comprises an inner thread. A pressure measuring device (not shown), e.g. a pressure gauge, can be screwed in the mounting mechanisms 231, 232, 233, 234 in order to measure the pressure in the connected conduit. The first mounting mechanism 231 is connected with the first conduit 211. The second mounting mechanism 232 is connected to the second 215. The third mounting mechanism 133 is connected to the third conduit 216. The fourth mounting mechanism 134 is connected to the fourth conduit 214. Therefore, the multi-adapter 200 comprises already the pressure measuring devices for measuring the pressure between two serially connected mechanical parts of the water cleaning system. This reduces further the size of the installed water cleaning system.

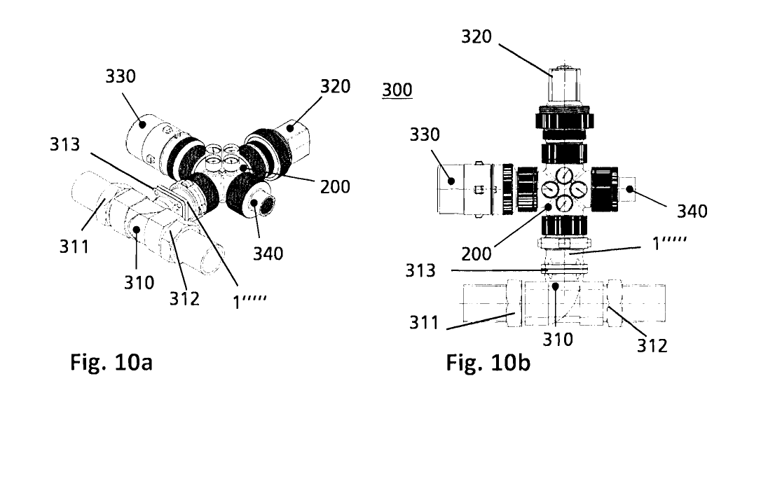

The FIG. 10a, b shows an exemplary water cleaning system 300 comprising a tube part 310, an adapter 1 as a third mechanical part, a multi-adapter 200, a shut-off valve 320 as a first mechanical part, a water meter 330 as a second mechanical part and an emergency water access 340 as a fourth mechanical part. FIG. 10a shows a three-dimensional view of the water cleaning system 300 and FIG. 10b shows a top view of the water cleaning system 300.

The tube part 310 comprises a first connection mechanism 311, a second connection mechanism 312 and third connection mechanism 313. The first connection mechanism 311 and the second connection mechanism 312 have each one opening. The third connection mechanism 313 in this embodiment is a rectangular flange which is connected to a flange of a mechanical part by four screws. The third connection mechanism 313 defines a connection surface which is covered by a mechanical part connected to the third connection mechanism 313, in this embodiment the surface of the flange. The tube part 310 comprises a first conduit (not shown) which connects the opening of the first connection mechanism 311 with a first opening of the third connection mechanism 313. The tube part 310 comprises a second conduit (not shown) which connects the opening of the second connection mechanism 312 with a second opening of the third connection mechanism 313. The first and second opening of the third connection mechanism 313 open both in the connection surface. This tube part is well-known in the state of the art for connecting a filter to the tube part 310.

Instead of connecting a filter, an adapter 1′″″ according to the fifth embodiment as shown in FIG. 6 is connected to the third connection mechanism 313 with the first connection mechanism 4′″″ of the adapter 1′″″. Therefore, both flanges are fixed with four screws or bolts. The second connection mechanism 5′″″ of the adapter 1′″″ is different from the first connection mechanism 4′″″ and configured to connect a multi-adapter 100 or 200 or a valve 320, an emergency water access 330, a water meter 340, a disinfection apparatus (not shown) or a pump (not shown) with only one connection mechanism to the water cleaning system 300. In the embodiment of the water cleaning system 300, a thread is chosen as a connection mechanism, because with a thread the connected mechanical part can be arranged in any rotational position which might be necessary if the space around the mechanical part is not sufficient. With a flange, the mechanical part can only be connected in four discrete positions. In this embodiment, the thread is left-handed. The adapter 1′″″ comprises further a ring 12 with a left-handed inner thread corresponding to the left-handed outer thread of the adapter 1′″″ and with a right-handed inner thread.

The multi-adapter 200 is connected with e.g. the third connection mechanism 203 to the second connection mechanism 5′″″ of the adapter 1′″″. However, the multi-adapter 200 can also be connected with any other of the connection mechanisms 201, 202 and 204 to the adapter 1′″″, because the connection mechanisms 201, 202, 203 and 204 are all configured to be connected to the second connection mechanism 50″″ of the adapter 1′″″. The choice of the connection mechanism 201, 202, 203 and 204 infers the order at which connection mechanisms the fluid flows out of the first opeining and at which connection mechanisms the fluid flows out of the second connection mechanisms. The third connection mechanism 203 and the second connection mechanism 5′″″ comprise cylinders with the same diameter comprising outer threads. The thread of the third connection mechanism 203 is right-handed corresponding to the inner thread of the ring 12 of the adapter 1′″″. Consequently, the multi-adapter 200 can be fixed by rotating the ring 12 such that the adapter 1″″ and the multi-adapter 200 are forced together with the corresponding connection surfaces 5.3 and 103.3 such that the seals of the first recesses 221 are pressed together and a sealing connection is achieved connecting the first conduit 2 and the third conduit 216 and connecting the second conduit 3 and the second conduit 215.

The shut-off valve 320 is connected to the fourth connection mechanism 204. The shut-off valve 320 comprises an inlet conduit and an outlet conduit connected by a valve mechanism. The shut-off valve 320 comprises a connection mechanism. The connection mechanism defines a surface on the valve 320 by the surface of the valve 320 covered and/or enclosed by a connected mechanical part like in this case the multi-adapter 200. The outlet conduit opens in a first opening of the connection surface of the valve 320 and the inlet conduit opens in a second opening of the connection surface of the valve 320. The first and second openings are arranged as in the multi-adapter 200. The connection mechanism of the valve 320 comprises an opposed handed thread compared to the thread of the fourth connection mechanism 204 and is connected to the fourth connection mechanism 204 by a ring with corresponding opposed handed inner threads.

The water meter 330 is connected to the second connection mechanism 202. The water meter 330 comprises an inlet conduit and an outlet conduit connected by a metering mechanism for measuring the amount of water passed from the inlet conduit to the outlet conduit of the water meter 330. The water meter 330 comprises a connection mechanism. The connection mechanism defines a surface on the water meter 330 by the surface of the water meter 330 covered and/or enclosed by a connected mechanical part like in this case the multi-adapter 200. The outlet conduit opens in a first opening of the connection surface of the water meter 330 and the inlet conduit opens in a second opening of the connection surface of the water meter 330. The first and second openings are arranged as in the multi-adapter 200. The connection mechanism of the water meter 330 comprises an opposed handed thread compared to the thread of the second connection mechanism 203 and is connected to the second connection mechanism 203 by a ring with corresponding opposed handed inner threads.

The emergency water access 340 is connected to the first connection mechanism 201. The emergency water access 340 comprises an inlet conduit and an outlet conduit which are connected. The emergency water access 340 comprises a manual mechanism for opening an outlet for letting water out. If the outlet is closed, the water flows from the inlet conduit in the outlet conduit. The emergency water access 340 comprises a connection mechanism. The connection mechanism defines a surface on the emergency water access 340 by the surface of the emergency water access 340 covered and/or enclosed by a connected mechanical part like in this case the multi-adapter 200. The inlet conduit opens in a first opening of the connection surface of the emergency water access 340 and the outlet conduit opens in a second opening of the connection surface of the emergency water access 340. The first and second openings are arranged as in the multi-adapter 200. The connection mechanism of the emergency water access 340 comprises an opposed handed thread compared to the thread of the fourth connection mechanism 204 and is connected to the fourth connection mechanism 204 by a ring with corresponding opposed handed inner threads.

Therefore, the shown part of the water cleaning system 300 allows to opening and closing the shut-off valve 320, when a sensor detects a malfunction of the water cleaning system. Consequently, no water leaves the water cleaning system 300 through the multi-adapter 200, when a malfunction is detected, because the shut-off valve 320 does closes the connection of the first opening 204.1 and of the second opening 204.2. In this case, water can be taken from the emergency water access 340, which is upstream of the shut-off valve 320. The emergency water access 340 can be opened manually and the water taken out could be disinfected manually. In any case, the water meter 330 counts the amount of water left by the emergency water access 340 or gone through the emergency water access 340 and the shut-off valve 320, because the water meter 330 is arranged upstream of the emergency water access 340 and of the shut-off valve 320.

Even if not shown, it is obvious to a person skilled in the art that any mechanical part of a water system like any valve, any water meter, any pump, any water outlet, any disinfection apparatus can be connected to such a multi-adapter 100 or 200 or to a simple adapter 1, if the valve, water meter, pump, water outlet or disinfection apparatus has a connection mechanism according to the invention including a first opening connected to the inlet and a second opening connected to the outlet of the valve, water meter, pump, water outlet or disinfection apparatus, respectively. As already mentioned before, a pump could be connected in order to pump water from a water container in the water cleaning system. Especially, small pumps like vortex pumps are used to clean disinfection apparatuses connected to the multi-adapter 100 or 200. A disinfection apparatus can be connected to a filter to the multi-adapter 100 or 200 in order to disinfect the water for the water cleaning system. Details for such a disinfection apparatus are shown in the European patent EP1755690. The variability of the multi-adapter 100 and 200 is incredibly large. For example by turning the multi-adapter 100 and 200 and using other connection mechanisms and/or using other openings as water inlet, different mechanical parts and different ways of connection (parallel, serial, etc.) can be achieved with a large number of mechanical parts.

The multi-adapter 200 shows four pressure measuring devices such that the pressure in each conduit 211, 213, 215 and 214 can be controlled.

1. Valve for a water cleaning system comprising
a connection mechanism for connecting the valve to a water cleaning system, wherein a connection surface of the valve is defined by the surface of the valve enclosed within the connection mechanism by the connected water cleaning system, when the valve is connected to said water cleaning system;
an inlet conduit;
an outlet conduit;
a valve mechanism connecting the inlet conduit with the outlet conduit;
whereby the inlet conduit and the outlet conduit open within the connection surface.

2. Water meter for a water cleaning system comprising
a connection mechanism for connecting the water meter to a water cleaning system, wherein a connection surface of the water meter is defined by the surface of the water meter enclosed within the connection mechanism by the connected water cleaning system, when the water meter is connected to said water cleaning system;
an inlet conduit;
an outlet conduit;
a metering mechanism for measuring the amount of water passed from the inlet conduit to the outlet conduit;
whereby the inlet conduit and the outlet conduit open within the connection surface.

3. Pump for a water cleaning system comprising
a connection mechanism for connecting the pump to a water cleaning system, wherein a connection surface of the pump is defined by the surface of the pump enclosed within the connection mechanism by the connected water cleaning system, when the pump is connected to said water cleaning system;
an inlet conduit;
an outlet conduit;
wherein the pump is configured to receive water from the inlet conduit and pump the fluid in the outlet conduit;
whereby the inlet conduit and the outlet conduit open within the connection surface.

4. Disinfection apparatus for a water cleaning system comprising
a connection mechanism for connecting the disinfection apparatus to a water cleaning system, wherein a connection surface of the disinfection apparatus is defined by the surface of the disinfection apparatus enclosed within the connection mechanism by the connected water cleaning system, when the disinfection apparatus is connected to said water cleaning system;
an inlet conduit;
an outlet conduit;
a means for disinfecting water connecting the inlet conduit and the outlet conduit;
whereby the inlet conduit and the outlet conduit open within the connection surface.

5. Adapter for a water cleaning system comprising
a first connection mechanism for connecting a first mechanical part to said adapter, wherein a first connection surface of the adapter is defined by the surface of the adapter enclosed within the first connection mechanism by the first mechanical part, when the first mechanical part is connected to said first connection mechanism,
a second connection mechanism for connecting a second mechanical part to said adapter, wherein a second connection surface of the adapter is defined by the surface of the adapter enclosed within the second connection mechanism by the second mechanical part, when the second mechanical part is connected to said second connection mechanism,
a first conduit connecting a first opening in the first connection surface and a second opening in the second connection surface;
a second conduit connecting a second opening in the first connection surface and a first opening in the second connection surface.

6. Adapter according to claim 5, wherein the first opening and second opening of the first connection surface and the first connection mechanism are arranged such that the first conduit of the adapter is sealingly connected to a first conduit of the first mechanical part and the second conduit of the adapter is sealingly connected to a second conduit of the first mechanical part, when the first mechanical part is connected to the first connection mechanism and/or the first opening and second opening of the second connection surface and the second connection mechanism are arranged such that the first conduit of the adapter is sealingly connected to a first conduit of the second mechanical part and the second conduit of the adapter is sealingly connected to a second conduit of the second mechanical part, when the second mechanical part is connected to the second connection mechanism.

7. Adapter according to claim 5, wherein at least one of the connection mechanisms is configured to repeatedly connect and disconnect the at least one of the connection mechanisms with the corresponding mechanical part, wherein the at least one of the connection mechanisms establishes a sealed connection with the corresponding mechanical part, when the at least one of the connection mechanisms is connected with the corresponding mechanical part.

8. Adapter according to claim 5, wherein the second opening is concentrically arranged around the first opening within at least one of the connection surfaces.

9. Adapter according to claim 8, wherein the first opening and the second opening within at least one of the connection surfaces are arranged rotational symmetric around a common axis.

10. Adapter according to claim 5, wherein at least the second connection mechanism is not a flange.

11. Adapter according to claim 5, wherein the second connection mechanism is a thread.

12. Adapter according to claim 11, characterised in that the second connection mechanism is a left-hand thread.

13. Adapter according to claim 5, wherein the first connection mechanism is different from the second connection mechanism.

14. Adapter according to claim 5, wherein the first connection mechanism is a flange.

15. Adapter according to claim 5, wherein the first opening and the second opening are arranged within each connection surface in the same way and each connection mechanism is equal.

16. Adapter according to claim 5, wherein the second conduit is concentrically arranged around the first conduit.

17. Adapter according to claim 5 comprising further
a third connection mechanism for connecting a third mechanical part to said adapter, wherein a third connection surface of the adapter is defined by the surface of the adapter enclosed within the third connection mechanism by the third mechanical part, when the third mechanical part is connected to said third connection mechanism;
a third conduit connecting the first opening in the second connection surface and a first opening in the third connection surface;
a fourth conduit connecting a second opening in the third connection surface and the second opening in the first connection surface;
wherein the third conduit and fourth conduit form the second conduit.

18. Adapter according to claim 17 comprising further
a fourth connection mechanism for connecting a fourth mechanical part to said adapter, wherein a fourth connection surface of the adapter is defined by the surface of the adapter enclosed within the fourth connection mechanism by the fourth mechanical part, when the fourth mechanical part is connected to said fourth connection mechanism;
a fifth conduit connecting the first opening in the second connection surface and a first opening in the fourth connection surface;
a sixth conduit connecting a second opening in the fourth connection surface and the second opening in the first connection surface.

19. Adapter according to claim 17 comprising further
a fourth connection mechanism for connecting a fourth mechanical part to said adapter, wherein a fourth connection surface of the adapter is defined by the surface of the adapter enclosed within the fourth connection mechanism by the fourth mechanical part, when the fourth mechanical part is connected to said fourth connection mechanism;
a fifth conduit connecting the first opening in the second connection surface and a second opening in the fourth connection surface;
a sixth conduit connecting a first opening in the fourth connection surface and the first opening in the third connection surface;
wherein the fifth conduit and sixth conduit form the third conduit.

20. Adapter according to claim 5 further comprising at lest one mounting mechanism connected to the at least one of the conduits for mounting a pressure measuring device for measuring the pressure in the conduit connected.

21. Adapter according to claim 20 further comprising a first mounting mechanism connected to the first conduit for mounting a pressure measuring device for measuring the pressure in the first conduit and a second mounting mechanism connected to the second conduit for mounting a pressure measuring device for measuring the pressure in the second conduit.

22. Adapter according to claim 17 further comprising a first mounting mechanism connected to the first conduit for mounting a pressure measuring device for measuring the pressure in the first conduit, a second mounting mechanism connected to the second conduit for mounting a pressure measuring device for measuring the pressure in the second conduit and a third mounting mechanism connected to the third conduit for mounting a pressure measuring device for measuring the pressure in the third conduit.

23. Adapter according to claim 18 further comprising a first mounting mechanism connected to the first conduit for mounting a pressure measuring device for measuring the pressure in the first conduit, a second mounting mechanism connected to the second conduit for mounting a pressure measuring device for measuring the pressure in the second conduit, a third mounting mechanism connected to the third conduit for mounting a pressure measuring device for measuring the pressure in the third conduit and a fourth mounting mechanism connected to the fourth conduit for mounting a pressure measuring device for measuring the pressure in the fourth conduit.

24. Adapter according to claim 20 further comprising at least a pressure measuring means connected to the at lest one mounting mechanism.

25. System for water cleaning comprising;
an adapter and a first mechanical part being one of a valve, a water meter, a pump, a disinfection apparatus, a water outlet and a filter,
wherein the adapter comprises:
a first connection mechanism connected to the first mechanical part, wherein a first connection surface of the adapter is defined by the surface of the adapter enclosed within the first connection mechanism by the first mechanical part,
a second connection mechanism for connecting a second mechanical part to said adapter, wherein a second connection surface of the adapter is defined by the surface of the adapter enclosed within the second connection mechanism by the second mechanical part, when the second mechanical part is connected to said second connection mechanism,
a first conduit connecting a first opening in the first connection surface and a second opening in the second connection surface;
a second conduit connecting a second opening in the first connection surface and a first opening in the second connection surface;
wherein the first mechanical part comprises:
a connection mechanism connected to the first connection mechanism of the adapter, wherein a connection surface of the mechanical is defined by the surface of the mechanical enclosed within the connection mechanism by the connected adapter;
an inlet conduit opening in the connection surface and connected to the first conduit of the adapter;
an outlet conduit opening in the connection surface and connected to the second conduit of the adapter.

26. System according to claim 25, wherein the connection mechanism of the first mechanical part and the first connection mechanism are threads, one left-handed and the other right-handed, and the connection mechanism of the first mechanical part and the first connection mechanism are connected by a ring with two opposed-handed threads.

27. System according to claim 25 further comprising a tube part with
a first connection mechanism for connecting another tube, wherein a first conduit opens within the first connection mechanism,
a second connection mechanism for connecting another tube, wherein a second conduit opens within the second connection mechanism,
a third connection mechanism connected to the second connection mechanism of the adapter, wherein a connection surface of the tube part is defined by the surface of the tube part enclosed within the third connection mechanism by the adapter and wherein the first opening of the second connection mechanism of the adapter is connected within the connection surface of the tube part to the first conduit of the tube part and the second opening of the second connection mechanism of the adapter is connected within the connection surface of the tube part to the second conduit of the tube part.

28. System according to claim 27, wherein the third connection mechanism of the tube part is a flange and the other connection mechanism of the adapter is not a flange and a further adapter is arranged between the third connection mechanism of the tube part and the second connection mechanism of the adapter.

29. (canceled)
